(19) United States
(12) Patent Application Publication
(10) Pub. No.: US 2005/0192051 A1
(43) Pub. Date: Sep. 1, 2005

(54) Mobile terminal-based remote control technique

(75) Inventor: Hidekazu Tokuhashi, Osaka-fu (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/049,632

(22) Filed: Feb. 3, 2005

(30) Foreign Application Priority Data
Feb. 3, 2004 (JP) 2004-027050

(51) Int. Cl. H04B 7/00; H04Q 7/20; H04M 1/00

(52) U.S. Cl. 455/556.1

(57) ABSTRACT

A remote control program installed in a cell phone is activated to read a window number allocated to an operation window output and displayed on a TV receiver from a memory unit of the cell phone and to display corresponding help information on a display unit of the cell phone (steps S100 and S110). In response to the user's manipulation of one of buttons on an operation unit of the cell phone, the remote control program displays button function information representing the functions of the respective buttons on the operation unit, while converting an input signal into an operation signal and sending the converted operation signal together with the window number (steps S120 to S150).

### BACKGROUND OF THE INVENTION

1. Field of the Invention

The present invention relates to a mobile terminal-based remote control technique. More specifically the invention pertains to a storage medium for storing a program, which is to be installed in a mobile terminal for remote controlling a specified device, where the mobile terminal includes a display unit that displays letters, characters, and images and an operation unit that receives an entry of a user's operation, has a predetermined wireless communication function, and is capable of establishing communication via a predetermined communication line. The invention also pertains to a server computer for distributing such a program, as well as to a remote control system with the mobile terminal and a corresponding remote control method using the mobile terminal.

2. Description of the Prior Art

One proposed operation signal transmitter is a remote control that remote controls a TV receiver and other devices connected with the TV receiver (see, for example, Japanese Patent Laid-Open Gazette No. 2003-078779). In the remote control system, the user refers to various windows displayed on a TV screen and operates the remote control to remote control the TV receiver and the other devices connected with the TV receiver.

### SUMMARY OF THE INVENTION

Inexperienced users may have difficulties in smooth operations of the remote control and may thus be forced to refer to the written instructions manual for the smooth operations of the remote control. Description of the operations may be displayed in various windows on the TV screen. The displayed information may, however, be insufficient because of the limited space of the TV screen. Such constant display of information may, on the other hand, be rather annoying to experienced users.

The mobile terminal-based remote control technique of the invention aims to readily operate a specified device by remote control with a mobile terminal. The mobile terminal-based remote control technique of the invention also aims to adequately provide the user with support information relating to the operations of a specified device.

At least part of the above and the other related objects is attained by the mobile terminal-based remote control technique of the invention that is embodied in various applications discussed below.

A storage medium of the invention stores a program therein, the program causes a mobile terminal to function as an operation signal transmitter for remote controlling a specified device, where the mobile terminal includes a display unit that displays letters, characters, and images and an operation unit that receives an entry of an user's operation, has a predetermined wireless communication function, and is capable of establishing communication via a predetermined communication line, and
the program includes:
an operation signal transmission module that converts a signal input by the operation unit of the mobile terminal into an operation signal for the specified device and activates the predetermined wireless communication function to send the operation signal; and
a support information output module that outputs and displays support information regarding operation of the specified device on the display unit of the mobile terminal.

The program stored in the storage medium of the invention causes the mobile terminal to function as the operation signal transmitter that converts a signal input by the operation unit into an operation signal for the specified device, sends the operation signal, and outputs and displays support information regarding the operation of the specified device on the display unit. The mobile terminal is thus used as the operation signal transmitter for remote controlling the specified device, while the support information is displayed on the display unit of the mobile terminal. The user refers to the support information displayed on the display unit of the mobile terminal and thereby readily remote controls the specified device. A typical example of the ‘mobile terminal’ is a cell phone.

In one embodiment of the storage medium of the invention, the mobile terminal may have a support information memory unit that stores the support information, and the support information output module may read the support information from the support information memory unit and output and display the support information on the display unit of the mobile terminal. Further in the storage medium of the invention, the operation unit of the mobile terminal may have multiple mobile terminal buttons, and the support information output module may output and display information representing a mapping of the multiple mobile terminal buttons to operation specifications of the specified device as the support information. In this embodiment, the specified device may be operable by a dedicated operation signal transmitter that has multiple operation buttons and send an operation signal for the specified device in response to an operation of one of the multiple operation buttons, and the support information output module may output and display information representing a mapping of the multiple mobile terminal buttons of the mobile terminal to the multiple operation buttons of the dedicated operation signal transmitter as the support information.

In another embodiment of the storage medium of the invention, the specified device may output and display an operation window relating to operation of the specified device on a display device, and the support information output module may output and display supplementary information regarding the operation window as the support information.

In still another embodiment of the storage medium of the invention, the mobile terminal may have a device state memory unit that stores device state information representing a state of the specified device, and the support information output module may output and display support information corresponding to the state of the specified device represented by the device state information stored in the device state memory unit of the mobile terminal. In this embodiment, the program may further include a synchronization control module that synchronizes an actual state of the specified device with the device state information stored in the device state memory unit. Moreover, the synchronization control module may control the operation signal transmission module to send the device state information stored in the device state memory unit, together with the operation signal, and update the device state information stored in the device state memory unit to represent a state of the specified device after operation in response to the operation signal. The specified device may output and display an operation window relating to operation of the specified device on a display device, and the device state information may represent a state of the operation window.

In the mobile terminal where the storage medium of the invention is incorporated, the program may be downloaded from a computer, which establishes communication with the mobile terminal via the predetermined communication line, into the mobile terminal via the predetermined communication line and may be installed into the mobile terminal.

A server computer of the invention includes:
a storage module that stores at least part of an operation signal transmitter program causing a mobile terminal to function as an operation signal transmitter for remote controlling a specified device, where the mobile terminal includes a display unit that displays letters, characters, and images and an operation unit that receives an entry of an user's operation, has a predetermined wireless communication function, and is capable of establishing communication via a predetermined communication line, and including: an operation signal transmission module that converts a signal input by the operation unit of the mobile terminal into an operation signal for the specified device and activates the predetermined wireless communication function to send the operation signal; and a support information output module that outputs and displays support information regarding operation of the specified device on the display unit of the mobile terminal; and
a distribution module that distributes at least part of the operation signal transmitter program stored in the storage module to the mobile terminal via the predetermined communication line.

The server computer of the invention distributes the operation signal transmitter program to the mobile terminal via the predetermined communication line. The operation signal transmitter program is thus downloaded to and installed in the mobile terminal, which is capable of establishing communication via the predetermined communication line.

A remote control system of the invention includes a mobile terminal that has a predetermined wireless communication function and is capable of establishing communication via a predetermined communication line, and a specified device that receives data sent by the predetermined wireless communication function,
the mobile terminal includes: a display unit that displays letters, characters, and images; an operation unit that receives an entry of an user's operation; an operation signal transmission unit that converts a signal input by the operation unit of the mobile terminal into an operation signal for the specified device and activates the predetermined wireless communication function to send the operation signal; and a support information output unit that outputs and displays support information regarding operation of the specified device on the display unit of the mobile terminal, and
the specified device include: a receiver analyzer unit that receives and analyzes the operation signal sent from the operation signal transmission unit of the mobile terminal; and an operation control unit that controls respective elements of the specified device in response to the analyzed operation signal.

In the remote control system of the invention, the mobile terminal converts a signal input by the operation unit into an operation signal for the specified device, sends the operation signal, and outputs and displays support information regarding the operation of the specified device on the display unit. The specified device receives and analyzes the operation signal and controls the respective elements in response to the analyzed operation signal. In this remote control system, the mobile terminal is used to remote control the specified device, while the support information is displayed on the display unit of the mobile terminal. This arrangement enables the user to readily remote control the specified device.

In the remote control system of the invention, the mobile terminal may further include: a device state memory unit that stores device state information representing a state of the specified device; and a synchronization control unit that controls the operation signal transmission unit to send the device state information stored in the device state memory unit, together with the operation signal, and updates the device state information stored in the device state memory unit to represent a state of the specified device after operation in response to the operation signal, the receiver analyzer unit of the specified device may receive and analyze the device state information together with the operation signal, and when the state of the specified device represented by the analyzed device state information is different from an actual state of the specified device, the operation control unit of the specified device may switche over the actual state to the state represented by the analyzed device state information and control the respective elements of the specified device in response to the analyzed operation signal. Further, the specified device may be a printer including: a display output control unit that outputs and displays an operation window relating to operation of the specified device on a selected display device; a print setting unit that specifies print-relating settings based on information entered on the operation window; and a print execution unit that prints an image according to the specified print-relating settings.

A remote control method of the invention remote controls a specified device, and installs an operation signal transmitter program into a mobile terminal and thereby causes the mobile terminal to function as an operation signal transmitter for remote controlling the specified device,
where the mobile terminal includes a display unit that displays letters, characters, and images and an operation unit that receives an entry of an user's operation, has a predetermined wireless communication function, and is capable of establishing communication via a predetermined communication line, and
the operation signal transmitter program includes an operation signal transmission module that converts a signal input by the operation unit of the mobile terminal into an operation signal for the specified device and activates the predetermined wireless communication function to send the operation signal; and a support information output module that outputs and displays support information regarding operation of the specified device on the display unit of the mobile terminal.

The remote control method of the invention causes the mobile terminal to function as the operation signal transmitter that converts a signal input by the operation unit into an operation signal for the specified device, sends the operation signal, and outputs and displays support information regarding the operation of the specified device on the display unit. The mobile terminal is thus used as the operation signal transmitter for remote controlling the specified device, while the support information is displayed on the display unit of the mobile terminal. The user refers to the support information displayed on the display unit of the mobile terminal and thereby readily remote controls the specified device. A typical example of the ‘mobile terminal’ is a cell phone.

In one embodiment of the remote control method of the invention, the mobile terminal may have a support information memory unit that stores the support information, and the support information output module may read the support information from the support information memory unit and output and display the support information on the display unit of the mobile terminal. The operation unit of the mobile terminal may have multiple mobile terminal buttons, and the support information output module may output and display information representing a mapping of the multiple mobile terminal buttons to operation specifications of the specified device as the support information. Further, the specified device may output and display an operation window relating to operation of the specified device on a display device, and the support information output module may output and display supplementary information regarding the operation window as the support information. Moreover, the mobile terminal may have a device state memory unit that stores device state information representing a state of the specified device, and the support information output module may output and display support information corresponding to the state of the specified device represented by the device state information stored in the device state memory unit of the mobile terminal. In addition, the operation signal transmitter program may be downloaded from a computer, which establishes communication with the mobile terminal via the predetermined communication line, into the mobile terminal via the predetermined communication line and may be installed into the mobile terminal.

### BRIEF DESCRIPTION OF THE DRAWINGS

FIG. 1 schematically illustrates the configuration of a remote control system in one embodiment of the invention;

FIG. 2 shows the appearance of a dedicated remote control;

FIG. 3 is a flowchart showing a remote control mode processing routine;

FIG. 4 shows one example of help information and an operation window displayed on a TV receiver;

FIG. 5 shows a display unit with button function information;

FIG. 6 shows another example of the help information and the operation window displayed on the TV receiver; and

FIG. 7 is a flowchart showing an operation signal reception processing routine.

### DESCRIPTION OF THE PREFERRED EMBODIMENTS

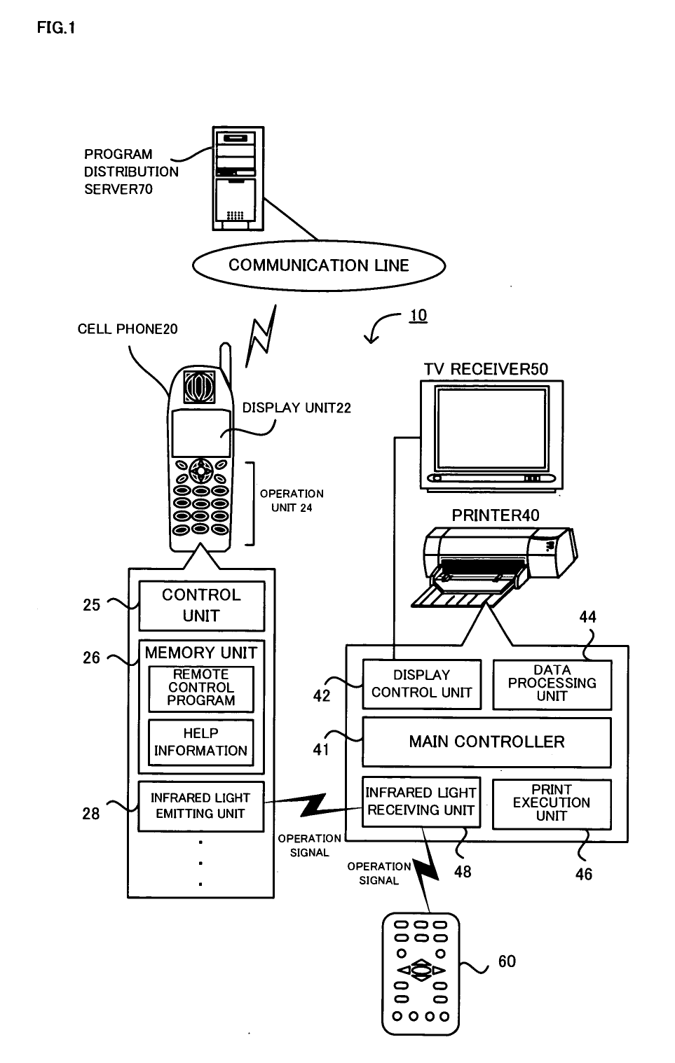

One mode of carrying out the invention is described below as a preferred embodiment. FIG. 1 schematically illustrates the configuration of a remote control system 10 including a cell phone 20 with a program for remote control installed therein as a program for an operation signal transmitter in one embodiment of the invention. As illustrated, the remote control system 10 includes the cell phone 20 that establishes voice and data communication via a predetermined communication line and a printer 40 that prints letters, characters, and images on paper. The printer 40 is remotely controlled in response to operation signals (remote control signals) sent from the cell phone 20.

The cell phone 20 includes a display unit 22 that displays letters, characters, and images, an operation unit 24 that includes multiple buttons and receives entries of a user's operations, a control unit 25 that controls the whole cell phone 20, a memory unit 26 that stores data, an infrared light emitting unit 28 that sends infrared light signals, and diversity of other elements (including an antenna and a speaker) generally required for the cell phone. The memory unit 26 stores a remote control program that enables the cell phone 20 to function as a remote control of the printer 40 and help information with regard to operations of the printer 40. The remote control program and the help information are distributed from a program distribution server 70 via a preset communication line, which is used to establish data communication of the cell phone 20, and are installed into the memory unit 26 of the cell phone 20.

The printer 40 is constructed as an inkjet printer and is connected with a TV receiver 50, for example, via a dedicated cable. The printer 40 includes a main controller 41 that controls the whole printer 40, a display control unit 42 that controls display of images to be printed and output and display of an operation window for setting of printing conditions on the TV receiver 50, a data processing unit 44 that converts an image file to be printed into a printable format and executes diversity of other data processing, a print execution unit 46 that prints an image on printing paper according to the processed image file, and an infrared light receiving unit 48 that receives infrared light signals as operation signals sent from the cell phone 20 or a dedicated remote control 60. When the infrared light receiving unit 48 receives an operation signal, the main controller 41 analyzes the received operation signal and controls the display control unit 42, the data processing unit 44, and the print execution unit 46 based on a result of the analysis. The user checks the operation window output and displayed on the TV receiver 50, manipulates the cell phone 20 or the dedicated remote control 60 to select a desired image for printing and give a print start command.

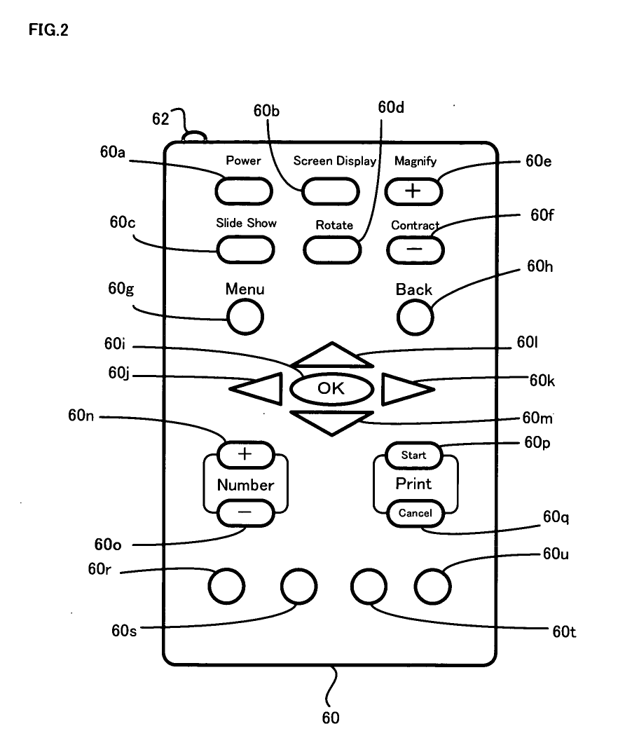

As shown by the appearance diagram of FIG. 2, the dedicated remote control 60 has various buttons manipulated to send operation signals to the printer 40. The various buttons include a power button 60a, a screen display button 60b to switch over the screen display, a slide show button 60c to start a slide show, a rotate button 60d to rotate an image, an expand button 60e and a contract button 60f to respectively expand and contract an image, a menu button 60g to display a menu, a back button 60h to return the processing or the screen display to a preceding state, an OK button 60k to settle the processing or selection of an image, four directional buttons (a left button 60j, a right button 60k, an up button 601, and a down button 60m) to shift a focus frame leftward, rightward, upward, and downward, a number up button 60n and a number down button 600 to increase and decrease the number of prints, a print start button 60p to start printing, a print cancel button 60q to cancel printing, and buttons 60r to 60u used for other operations. When the user manipulates one of the various buttons on the remote control 60, a built-in processing circuit (not shown) of the remote control 60 sends an infrared light signal as an operation signal corresponding to the manipulated button from a light emitting element 62.

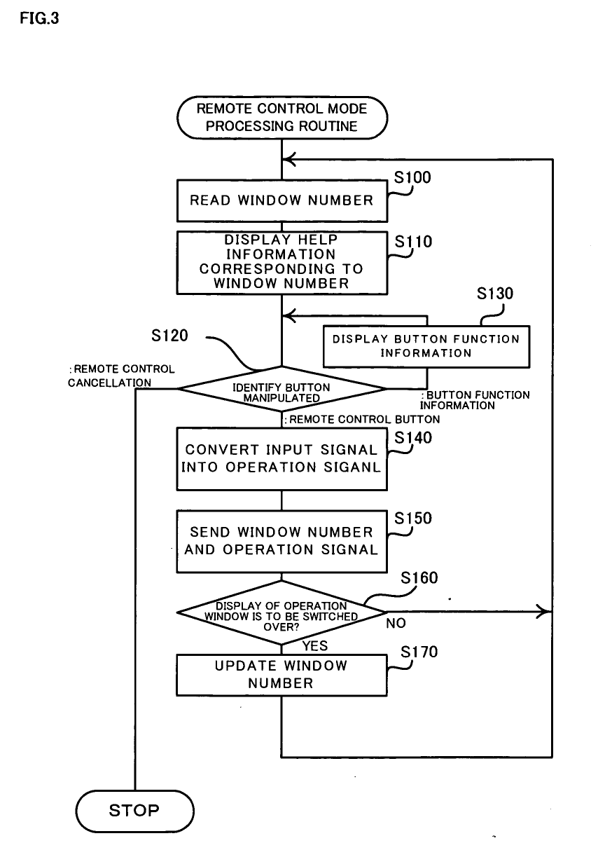

The following describes the operations of the remote control system 10 constructed as discussed above. The description regards first a series of processing executed by the cell phone 20 used as a remote control of the printer 40 and then a series of processing executed by the printer 40 in response to reception of an operation signal sent from the cell phone 20. FIG. 3 is a flowchart showing a remote control mode processing routine executed by the control unit 25 in a remote control mode where the cell phone 20 functions as a remote control of the printer 40. In this embodiment, the remote control program installed in the memory unit 26 is activated in response to a specified button operation on the operation unit 24 of the cell phone 20 to change over the operation mode of the cell phone 20 from a standard mode to a remote control mode.

When the remote control mode processing routine starts, the control unit 25 first reads a window number, which represents a current state of an operation window output from the printer 40 and displayed on the TV receiver 50, from the memory unit 26 of the cell phone 20 (step S100). The window number stored in the memory unit 26 is number information managed to represent the current state of the operation window output from the printer 40 and displayed on the TV receiver 50. An initial window number allocated to an initial state of the operation window output and displayed on the TV receiver 50 immediately after power supply to the printer 40 is set to an initial value of the window number. In a first cycle of the remote control mode processing routine, the initial window number allocated to the initial state of the operation window immediately after power supply to the printer 40 is read out at step S100.

The control unit 25 acquires help information corresponding to the read-out window number from the memory unit 26 and displays the acquired help information on the display unit 22 (step S110). In the structure of this embodiment, a mapping of the window number to the help information is specified and stored in advance in the memory unit 26. The help information corresponding to the window number is acquired according to the stored mapping and is displayed on the display unit 22.

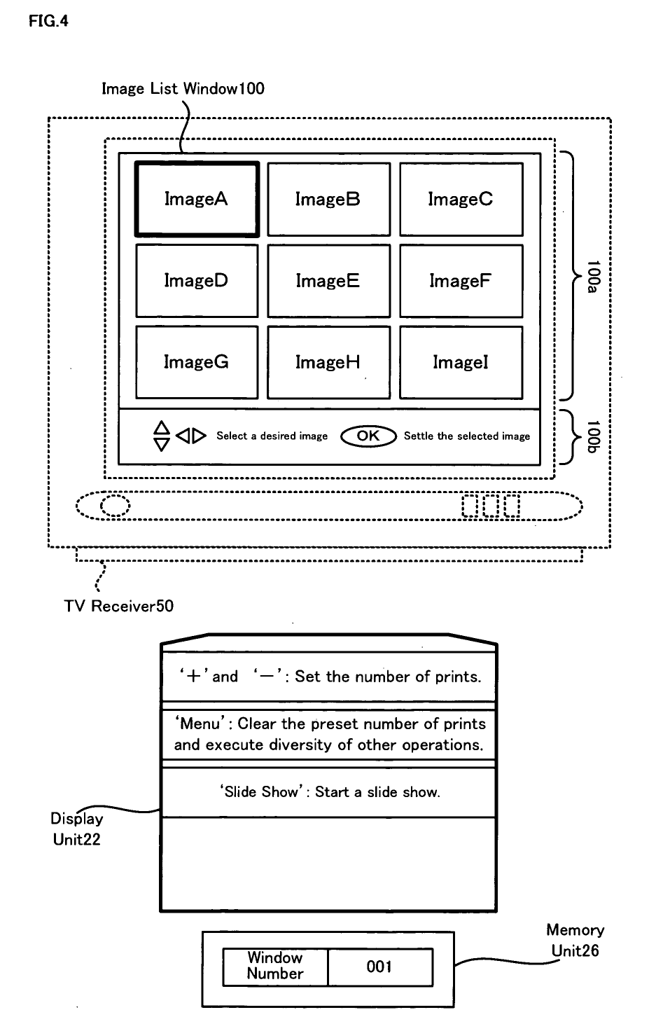

FIG. 4 shows one example of the operation window output and displayed on the TV receiver 50, the help information displayed on the display unit 22 of the cell phone 20, and the window number stored in the memory unit 26. This example shows the state after power supply to the printer 40 and changeover of the operation mode of the cell phone 20 from the standard mode to the remote control mode. As illustrated, an image list window 100 is output and displayed on the TV receiver 50 as the initial operation window immediately after power supply to the printer 40. The processing of steps S100 and S110 in the flowchart of FIG. 3 is executed to read out the initial window number that identifies the image list window 100 (‘001’ in the illustrated example of FIG. 4) and is stored in the memory unit 26 and to display the help information corresponding to the image list window 100 on the display unit 22 of the cell phone 20. As shown in FIG. 4, the image list window 100 includes an image display field 100a to display a list of images stored in, for example, a memory card set in a card slot of the printer 40 and an operation description field 100b to display description of available operations on the image list window 100. The operation description field 100b shows a method of selecting a desired image in the displayed list of images and a method of settling the selection as the description of available operations. The help information displayed on the display unit 22 of the cell phone 20 includes a method of setting the number of prints, the functions of the menu button 60g, and a method of starting a slide show. The description of fundamental operations is displayed in the operation description field loob of the image list window 100, whereas the supplementary description of additional operations is displayed as the help information on the display unit 22 of the cell phone 20. The user accordingly refers to the operation description field 100b of the image list window 100 output and displayed on the TV receiver 50 to make fundamental operations, while referring to the help information displayed on the display unit 22 of the cell phone 20 to make relatively complicated, additional operations.

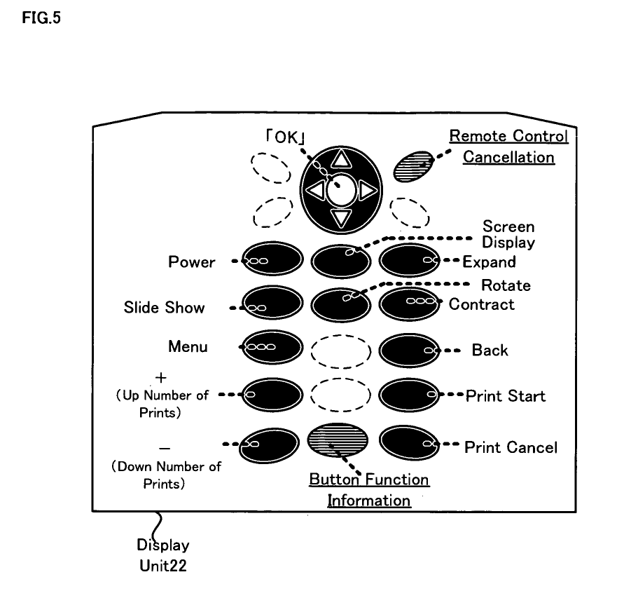

In response to the user's manipulation of one of the buttons on the operation unit 24 during the display of the help information on the display unit 22, the control unit 25 executes a series of processing corresponding to the manipulated button (steps S120 to S170). When the user manipulates a button for display of button function information regarding the functions of the respective buttons on the operation unit 24 among the buttons on the operation unit 24 (step S120), the control unit 25 displays the button function information as the help information on the display unit 22 (step S130) and stands by for another button operation. FIG. 5 shows one example of the button function information displayed on the display unit 22. The button function information is set as information representing a mapping of the respective buttons of the operation unit 24 to the functions allocated to the respective buttons of the dedicated remote control 60 and other functions (for example, cancellation of the remote control mode). The user refers to the button function information and checks the functions of the respective buttons on the operation unit 24 of the cell phone 20.

When the user manipulates one of remote control buttons for transmission of an operation signal (corresponding to the respective buttons of the dedicated remote control 60) among the buttons on the operation unit 24 (step S120), the control unit 25 converts an input signal of the manipulated button into a corresponding operation signal (step S140). In the structure of this embodiment, a mapping of the respective buttons on the operation unit 24 to operation signals is stored in advance in the memory unit 26. The input signal is converted into a corresponding operation signal according to the stored mapping.

After conversion of the input signal into the operation signal, the control unit 25 activates the infrared light emitting unit 28 to send the converted operation signal and the window number read at step S100 in the form of an infrared light signal (step S150), and determines whether the display of the operation window on the TV receiver 50 is to be switched over in response to the operation signal (step S160). When it is determined that the display of the operation window is to be switched over, the control unit 25 updates the window number stored in the memory unit 26 to a number corresponding to a new operation window after switchover (step S170) and returns to step S100. When it is determined that the display of the operation window is not to be switched over, on the other hand, the control unit 25 returns to step S100 with keeping the window number unchanged. In the structure of the embodiment, combinations of the window number with the operation signal that require switchover of the display of the operation window are stored in advance in the memory unit 26. The procedure of the embodiment compares the combination of the window number and the operation signal sent at step S150 with the combinations stored in the memory unit 26 and determines the requirement or non-requirement for switchover of the display of the operation window. For example, in the image list window 100 shown in FIG. 4, no switchover of the display of the operation window is required when the operation signal transmitted with the window number corresponds to any of the four directional buttons. Switchover of the display of the operation window is required, on the other hand, when the operation signal corresponds to an ‘OK’ button.

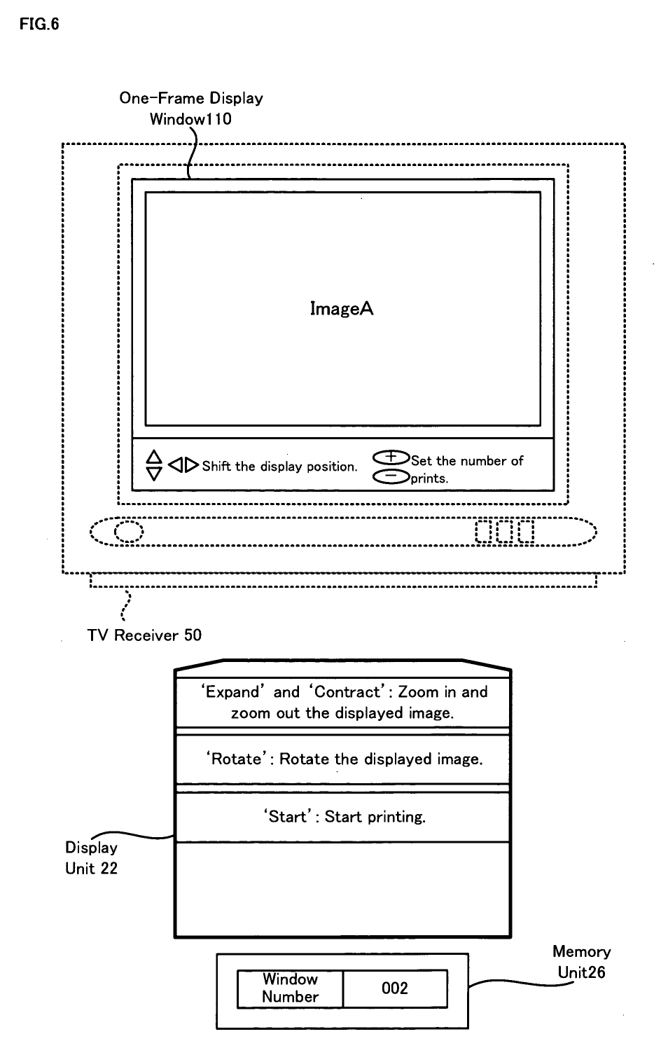

FIG. 6 shows an example of the operation window output and displayed on the TV receiver 50, the help information displayed on the display unit 22 of the cell phone 20, and the window number stored in the memory unit 26 when the user selects an image A and presses an OK button in the state of FIG. 4 (where the image list window 100 is output and displayed on the TV receiver 50 and the corresponding help information is displayed on the display unit 22 of the cell phone 20). In this example, the display on the TV receiver 50 is switched over from the image list window 100 to a one-frame display window 110 to display the selected image. The window number stored in the memory unit 26 of the cell phone 20 is updated to a number identifying the one-frame display window 110 (‘002’ in the illustrated example of FIG. 6) by the processing of step S170 in the flowchart of FIG. 3. Help information corresponding to the one-frame display window 110 is displayed on the display unit 22 of the cell phone 20 by the processing of steps S100 and S110 in the flowchart of FIG. 3. The state of the operation window output and displayed on the TV receiver 50 is managed with the window number stored in the memory unit 26. The display of the help information on the display unit 22 of the cell phone 20 is switched over, in response to the switchover of the display of the operation window on the TV receiver 50.

The control unit 25 exits from this remote control mode processing routine when the user manipulates a button for canceling the remote control mode among the buttons on the operation unit 24 (step S120).

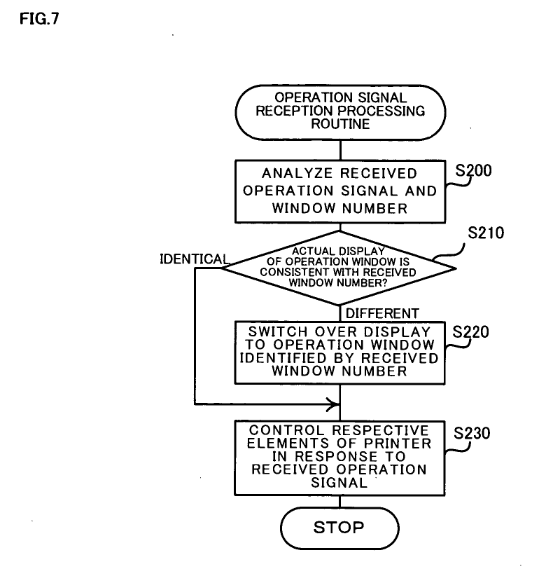

The description now regards the series of processing executed by the printer 40 in response to reception of an operation signal sent from the cell phone 20. FIG. 7 is a flowchart showing an operation signal reception processing routine executed by the main controller 41 of the printer 40 when the infrared light receiving element 48 receives an infrared light signal sent from the cell phone 20. When the operation signal reception processing routine starts, the main controller 41 first analyzes the received infrared light signal to extract the operation signal and the window number (step S200), and determines whether the operation window identified by the extracted window number is consistent with the operation window actually output and displayed on the TV receiver 50 (step S210). In the event of discrepancy, the main controller 41 switches over the display of the operation window on the TV receiver 50 to the operation window identified by the received window number (step S220). The discrepancy between the operation window identified by the received window number and the actual display of the operation window is ascribed to that the printer 40 fails to receive the infrared light signal sent from the cell phone 20, due to the distance between the cell phone 20 and the printer 40 or due to the orientation of the cell phone 20. In such cases, the operation window actually displayed on the TV receiver 50 may not correspond to the window number stored in the memory unit 26 of the cell phone 20. The processing of steps S210 and S220 switches over the display of the operation window on the TV receiver 50 by the printer 40 to the operation window identified by the received window number.

The main controller 41 controls the respective elements of the printer 40 including the display control unit 42, the data processing unit 44, and the print execution unit 46, in response to the operation signal analyzed at step S200 (step S230) and exits from the operation signal reception processing routine. In the case where the operation signal is sent from the dedicated remote control 60, no window number is sent together with the operation signal. The respective elements of the printer 40 are accordingly controlled only in response to the received operation signal.

As described above, the remote control system 10 of the embodiment uses the cell phone 20 as the remote control of the printer 40 and causes the help information stored in the memory unit 26 of the cell phone 20 to be displayed on the display unit 22. The user refers to the help information displayed on the display unit 22 of the cell phone 20 and thus readily and accurately operates the printer 40. The help information displayed on the display unit 22 is supplementary information to supplement the information in the operation window displayed on the TV receiver 50 (in the above embodiment, the description of the additional operations to supplement the description of the fundamental operations shown in the operation window) When the user can not make smooth operations with reference to only the operation window, the help information displayed on the display unit 22 of the cell phone 20 helps the user. The window number representing the current state of the operation window is stored in the memory unit 26 of the cell phone 20, and the help information corresponding to the stored window number, that is, to the current state of the operation window, is displayed on the display unit 22 of the cell phone 20. The window number is sent together with the operation signal from the cell phone 20 to the printer 40. In the event of discrepancy between the received window number and the actual display of the operation window, the printer 40 switches over the display to the operation window represented by the received window number to eliminate the discrepancy. This arrangement ensures synchronization of the actual display of the operation window with the window number managed in the memory unit 26 of the cell phone 20.

The display unit 22 and the operation unit 24 in the cell phone 20 of the embodiment respectively correspond to the display unit and the operation unit in the mobile terminal of the invention. The control unit 25 that executes the processing of steps S140 and S150 and the infrared light emitting unit 28 in the cell phone 20 of the embodiment correspond to the operation signal transmission unit in the mobile terminal of the invention. The control unit 25 that executes the processing of steps S100, S110, and S130 corresponds to the support information output unit in the mobile terminal of the invention. The control unit 25 that executes the processing of steps S150 to S170 corresponds to the synchronization control unit in the mobile terminal of the invention. The main controller 41 that executes the processing of step S200 and the infrared light receiving element 48 in the printer 40 of the embodiment correspond to the receiver analyzer unit in the specified device of the invention. The main controller 41 that executes the processing of steps S210 to S230 corresponds to the operation control unit in the specified device of the invention. The main controller 41 and the data processing unit 44 in the printer 40 of the embodiment correspond to the print setting unit in the specified device of the invention. The print execution unit 46 in the printer 40 of the embodiment corresponds to the print execution unit in the specified device of the invention. The module of the remote control program in the embodiment that causes the control unit 25 of the cell phone 20 to execute the processing of steps S140 and S150 corresponds to the operation signal transmission module in the program of the invention. The module of the remote control program that causes the control unit 25 of the cell phone 20 to execute the processing of steps S100, S110, and S130 corresponds to the support information output module in the program of the invention the module of the remote control program that causes the control unit 25 of the cell phone 20 to execute the processing of steps S150 to S170 corresponds to the synchronization control module in the program of the invention. The program distribution server 70 of the embodiment corresponds to the server computer of the invention.

In the structure of the embodiment, the help information displayed on the display unit 22 of the cell phone 20 is supplementary information to supplement the description of the fundamental operations shown in the operation window on the TV receiver 50. In one possible modification, the help information displayed on the display unit 22 may be partially or wholly identical with the information displayed in the operation window. The user may then refer to the description of the operations displayed on the display unit 22 of the cell phone 20 in the event of any difficulty in access to the display on the TV receiver 50. The help information is not restricted to the description of the operations of the printer 40 or the button function information but may be any pieces of information relating to the operations of the printer 40.

In the structure of the embodiment, the help information is installed in advance in the memory unit 26 of the cell phone 20. It is, however, not essential to store the help information in advance in the cell phone 20. For example, the help information corresponding to the window number may be downloaded from a specific server via a communication line and displayed on the display unit 22 at step S110 in the remote control mode processing routine of FIG. 3.

In the structure of the embodiment, the window number is sent together with the operation signal from the cell phone 20. Transmission of the window number may, however, be omitted. In this modification, the printer 40 can not eliminate a possible discrepancy between the selected window number and the actual display of the operation window. The cell phone 20 is thus designed to have the function of updating the window number stored in its memory unit 26 to a desired number. The user takes advantage of this function and manually changes the window number in the event of a discrepancy between the window number and the actual display of the operation window. The printer 40 is not required to compare the window number with the actual display of the operation window. This modified technique is suitably applied to the conventional remote control system to remote control the general printer with the dedicated remote control 60.

In the structure of the embodiment, when it is determined that the display of the operation window is to be switched over in response to the operation signal, the window number stored in the memory unit 26 is updated to the number corresponding to the new operation window after switchover. This auto window number update function may, however, be omitted. In this modification, the cell phone 20 is designed to have the function of updating the window number to a desired number. The user manually updates the window number.

The cell phone 20 of the embodiment stores the window number representing the current state of the operation window in the memory unit 26 and displays the help information corresponding to the stored window number on the display unit 22. Any piece of information representing the current status of the printer 40 may be stored in the memory unit 26, instead of the window number, and help information corresponding to the stored piece of information may be displayed on the display unit 22. Such display of the help information corresponding to the stored window number may, however, be omitted. In this modification, the user selects desired help information and displays the selected help information on the display unit 22 of the cell phone 20, irrespective of the current state of the operation window.

In the structure of the embodiment, the remote control program and the help information are distributed from the program distribution server 70 to the cell phone 20 via the predetermined communication line and are installed in the memory unit 26. This is, however, not restrictive at all, and any other suitable method may be adopted to install the remote control program and the help information.

In the remote control system 10 of the embodiment, the printer 40 receives the operation signal sent from the cell phone 20 and is accordingly remote controlled. Any mobile terminal other than the cell phone 20 may be used as a remote control of sending operation signals, as long as the mobile terminal includes a display unit that displays letters, characters, and images and an operation unit that receives entries of the user's operations, has a predetermined wireless communication function, and is capable of establishing communication via a predetermined communication line. The object of remote control is not restricted to the printer 40. Any of diverse devices that are remote controllable with the dedicated remote control 60 (for example, video cassette recorders, DVD players, and general printers without the function of outputting and displaying the operation window on the TV receiver 50) may be specified as the object of remote control.

The embodiment discussed above is to be considered in all aspects as illustrative and not restrictive. There may be many modifications, changes, and alterations without departing from the scope or spirit of the main characteristics of the present invention. The scope and spirit of the present invention are indicated by the appended claims, rather than by the foregoing description.

The disclosure of Japanese Patent Application No. 2004-027050 filed Feb. 3, 2004 including specification, drawings and claims is incorporated herein by reference in its entirety.

1. A storage medium that stores a program therein,
said program causing a mobile terminal to function as an operation signal transmitter for remote controlling a specified device, said mobile terminal including a display unit that displays letters, characters, and images and an operation unit that receives an entry of an user's operation, having a predetermined wireless communication function, and being capable of establishing communication via a predetermined communication line,
said program comprising:
an operation signal transmission module that converts a signal input by the operation unit of said mobile terminal into an operation signal for the specified device and activates the predetermined wireless communication function to send the operation signal; and
a support information output module that outputs and displays support information regarding operation of the specified device on the display unit of said mobile terminal.

2. A storage medium in accordance with claim 1, wherein said mobile terminal has a support information memory unit that stores the support information, and
said support information output module reads the support information from the support information memory unit and outputs and displays the support information on the display unit of said mobile terminal.

3. A storage medium in accordance with claim 1, wherein the operation unit of said mobile terminal has multiple mobile terminal buttons, and
said support information output module outputs and displays information representing a mapping of the multiple mobile terminal buttons to operation specifications of the specified device as the support information.

4. A storage medium in accordance with claim 3, wherein the specified device is operable by a dedicated operation signal transmitter that has multiple operation buttons and sends an operation signal for the specified device in response to an operation of one of the multiple operation buttons, and
said support information output module outputs and displays information representing a mapping of the multiple mobile terminal buttons of said mobile terminal to the multiple operation buttons of the dedicated operation signal transmitter as the support information.

5. A storage medium in accordance with claim 1, wherein the specified device outputs and displays an operation window relating to operation of the specified device on a display device, and
said support information output module outputs and displays supplementary information regarding the operation window as the support information.

6. A storage medium in accordance with claim 1, wherein said mobile terminal has a device state memory unit that stores device state information representing a state of the specified device, and
said support information output module outputs and displays support information corresponding to the state of the specified device represented by the device state information stored in the device state memory unit of said mobile terminal.

7. A storage medium in accordance with claim 6, wherein said program further comprises a synchronization control module that synchronizes an actual state of the specified device with the device state information stored in the device state memory unit.

8. A storage medium in accordance with claim 7, wherein said synchronization control module controls said operation signal transmission module to send the device state information stored in the device state memory unit, together with the operation signal, and updates the device state information stored in the device state memory unit to represent a state of the specified device after operation in response to the operation signal.

9. A storage medium in accordance with claim 6, wherein the specified device outputs and displays an operation window relating to operation of the specified device on a display device, and
the device state information represents a state of the operation window.

10. A mobile terminal with a storage medium in accordance with claim 1 incorporated therein,
wherein said program is downloaded from a computer, which establishes communication with said mobile terminal via the predetermined communication line, into said mobile terminal via the predetermined communication line and is installed into said mobile terminal.

11. A cell phone with a storage medium in accordance with claim 1 incorporated therein.

12. A server computer, comprising:
a storage module that stores at least part of an operation signal transmitter program, said operation signal transmitter program causing a mobile terminal to function as an operation signal transmitter for remote controlling a specified device, where said mobile terminal includes a display unit that displays letters, characters, and images and an operation unit that receives an entry of an user's operation, has a predetermined wireless communication function, and is capable of establishing communication via a predetermined communication line, said operation signal transmitter program comprising: an operation signal transmission module that converts a signal input by the operation unit of said mobile terminal into an operation signal for the specified device and activates the predetermined wireless communication function to send the operation signal; and a support information output module that outputs and displays support information regarding operation of the specified device on the display unit of said mobile terminal; and
a distribution module that distributes at least part of the operation signal transmitter program stored in said storage module to said mobile terminal via the predetermined communication line.

13. A remote control system comprising a mobile terminal that has a predetermined wireless communication function and is capable of establishing communication via a predetermined communication line, and a specified device that receives data sent by the predetermined wireless communication function,
said mobile terminal comprising: a display unit that displays letters, characters, and images; an operation unit that receives an entry of an user's operation; an operation signal transmission unit that converts a signal input by the operation unit of said mobile terminal into an operation signal for the specified device and activates the predetermined wireless communication function to send the operation signal; and a support information output unit that outputs and displays support information regarding operation of the specified device on the display unit of said mobile terminal, and
said specified device comprising: a receiver analyzer unit that receives and analyzes the operation signal sent from the operation signal transmission unit of said mobile terminal; and an operation control unit that controls respective elements of said specified device in response to the analyzed operation signal.

14. A remote control system in accordance with claim 13, wherein said mobile terminal further comprises: a device state memory unit that stores device state information representing a state of said specified device; and a synchronization control unit that controls the operation signal transmission unit to send the device state information stored in the device state memory unit, together with the operation signal, and updates the device state information stored in the device state memory unit to represent a state of said specified device after operation in response to the operation signal,
the receiver analyzer unit of said specified device receives and analyzes the device state information together with the operation signal, and
when the state of said specified device represented by the analyzed device state information is different from an actual state of said specified device, said operation control unit of said specified device switches over the actual state to the state represented by the analyzed device state information and controls the respective elements of said specified device in response to the analyzed operation signal.

15. A remote control system in accordance with claim 13, wherein said specified device is a printer comprising: a display output control unit that outputs and displays an operation window relating to operation of said specified device on a selected display device; a print setting unit that specifies print-relating settings based on information entered on the operation window; and a print execution unit that prints an image according to the specified print-relating settings.

16. A remote control method that remote controls a specified device, said remote control method installing an operation signal transmitter program into a mobile terminal and thereby causing said mobile terminal to function as an operation signal transmitter for remote controlling the specified device,
where said mobile terminal comprises a display unit that displays letters, characters, and images and an operation unit that receives an entry of an user's operation, has a predetermined wireless communication function, and is capable of establishing communication via a predetermined communication line, and
said operation signal transmitter program comprises an operation signal transmission module that converts a signal input by the operation unit of said mobile terminal into an operation signal for the specified device and activates the predetermined wireless communication function to send the operation signal; and a support information output module that outputs and displays support information regarding operation of the specified device on the display unit of said mobile terminal.

17. A remote control method in accordance with claim 16, wherein said mobile terminal has a support information memory unit that stores the support information, and
said support information output module reads the support information from the support information memory unit and outputs and displays the support information on the display unit of said mobile terminal.

18. A remote control method in accordance with claim 16, wherein the operation unit of said mobile terminal has multiple mobile terminal buttons, and
said support information output module outputs and displays information representing a mapping of the multiple mobile terminal buttons to operation specifications of the specified device as the support information.

19. A remote control method in accordance with claim 16, wherein the specified device outputs and displays an operation window relating to operation of the specified device on a display device, and
said support information output module outputs and displays supplementary information regarding the operation window as the support information.

20. A remote control method in accordance with claim 16, wherein said mobile terminal has a device state memory unit that stores device state information representing a state of the specified device, and
said support information output module outputs and displays support information corresponding to the state of the specified device represented by the device state information stored in the device state memory unit of said mobile terminal.

21. A remote control method in accordance with claim 1 6,
wherein said operation signal transmitter program is downloaded from a computer, which establishes communication with said mobile terminal via the predetermined communication line, into said mobile terminal via the predetermined communication line and is installed into said mobile terminal.

22. A remote control method in accordance with claim 16, wherein said mobile terminal is a cell phone.
